(19) United States
(12) Patent Application Publication
(10) Pub. No.: US 2015/0201205 A1
(43) Pub. Date: Jul. 16, 2015

(54) VIDEO DECODING APPARATUS USING FRAME CACHE AND VIDEO DECODING METHOD PERFORMED BY THE SAME

(71) Applicant: Electronics and Telecommunications Research Institute, Daejeon (KR)

(72) Inventor: Jae Jin LEE, Daejeon (KR)

(21) Appl. No.: 14/595,959

(22) Filed: Jan. 13, 2015

(30) Foreign Application Priority Data
Jan. 16, 2014 (KR) 10-2014-0005399

(51) Int. Cl. H04N 19/423; H04N 19/187; G06F 12/08

(52) U.S. Cl. CPC H04N 19/423; G06F 12/0875; H04N 19/187; G06F 2212/452

(57) ABSTRACT

Provided are a video decoding apparatus using a frame cache, and a video decoding method performed by the same. The video decoding apparatus includes an address decoding unit configured to determine an area of a memory to be accessed by a processor core based on an address of the memory received from the processor core, a data cache unit configured to cache data required to decode a video in a cache memory operating in conjunction with a data memory so that the processor core accesses an area of the data memory, and a frame cache unit configured to cache frames of the video in the cache memory operating in conjunction with a frame memory so that the processor core accesses an area of the frame memory. Therefore, a delay caused by a cache clear is minimized, so that the performance of a video decoding system can be improved.

### CLAIM FOR PRIORITY

This application claims priority to Korean Patent Application No. 10-2014-0005399 filed on Jan. 16, 2014 in the Korean Intellectual Property Office (KIPO), the entire contents of which are hereby incorporated by reference.

### BACKGROUND

1. Technical Field

Example embodiments of the present invention relate in general to video decoding technology, and more particularly, to a video decoding apparatus which uses a frame cache to minimize performance degradation caused by a cache clear in a processor-based video decoding system and a video decoding method using the video decoding apparatus.

2. Related Art

Along with the recent rapid development of high-definition and high-sound-quality multimedia services, such as high-definition television (HDTV) and ultra HDTV, active research is being done on a video encoding technology and a video decoding technology for rapidly and accurately transmitting a multimedia service via a broadband communication network.

Thus far, various video standards, such as H.264/advanced video coding (AVC), VC-1, audio video coding standard (AVS), high efficiency video coding (HEVC), and scalable video coding (SVC), have been developed and commercialized. These video standards are expected to be used in various fields, such as digital home appliances, games, and next-generation mobile communication services, in addition to digital data broadcasting and communication, such as three-dimensional television (3DTV), Internet protocol television (IPTV), and satellite digital multimedia broadcasting (DMB).

Therefore, there is a trend toward developing video compression technology for the purpose of providing a multimedia service in real time by reducing a bandwidth while maintaining a compressed video as similar in image quality to the original as possible. Accordingly, a video decoding system which is based on a high-performance processor and can decompress compressed images in real time is in demand.

FIGS. 1A and 1B are an example diagram of an existing video decoding system.

Referring to FIGS. 1A and 1B, an existing video decoding system 10 may include a processor 20 including a processor core 21, an instruction cache 23, and a data cache 25, and a memory 30 including a program memory 31, a data memory 33, and a frame memory 35.

The existing video decoding system 10 may be generally classified as one of two types according to a method of accessing the frame memory 35. First, as shown in FIG. 1A, the processor core 21 may directly access the frame memory 35 to read or write a frame.

With this method, it is easy to maintain data consistency. However, the method requires an additional element, such as a memory management unit (MMU), so that the processor core 21 can directly access the frame memory 35, and the processor core 21 is required to always access the frame memory 35 to read or write a frame. For these reasons, the performance of the video decoding system 10 may be degraded.

Therefore, as shown in FIG. 1B, the processor core 21 may be configured to access the frame memory 35 through the data cache 25 to read or write a frame. According to this method, by temporarily storing a frame that the processor core 21 frequently accesses in the data cache 25, it is possible to minimize a delay caused by the method in which the processor core 21 directly accesses the frame memory 35.

However, every time the processor core 21 reads or writes a frame, a cache clear for maintaining data consistency between a cache memory and a memory is performed by storing a program or an instruction stored in the instruction cache 23 to the program memory 31 and recording data or a frame stored in the data cache 25 to the data memory 33 and the frame memory 35, so that a delay may occur. Due to the delay, the performance of the video decoding system 10 may be degraded.

### SUMMARY

Accordingly, example embodiments of the present invention are proposed to substantially obviate one or more problems of the related art as described above, and provide a video decoding apparatus which uses a frame cache to minimize performance degradation caused by a cache clear process in a processor-based video decoding system and thereby can improve the performance of the video decoding system.

Example embodiments of the present invention also provide a video decoding method which uses a frame cache and can be applied to various video standards, such as H.264/advanced video coding (AVC), VC-1, audio video coding standard (AVS), high efficiency video coding (HEVC), and scalable video coding (SVC), to perform video decoding.

Other purposes and advantages of the present invention can be understood through the following description, and will become more apparent by example embodiments of the present invention. Also, it is to be understood that purposes and advantages of the present invention can be easily achieved by means disclosed in claims and a combination of them.

In some example embodiments, a video decoding apparatus using a frame cache is implemented by a video decoding system and includes: an address decoding unit configured to determine an area of a memory to be accessed by a processor core based on an address of the memory received from the processor core; a data cache unit configured to cache data required to decode a video in a cache memory operating in conjunction with a data memory so that the processor core accesses an area of the data memory due to the address decoding unit; and a frame cache unit configured to cache frames of the video in the cache memory operating in conjunction with a frame memory so that the processor core accesses an area of the frame memory due to the address decoding unit.

Here, areas of the memory may be classified as: a program memory configured to store a program for decoding the video; the data memory configured to store the data required to decode the video; and the frame memory configured to store the video decoded by the processor core in the form of frames, and the respective classified areas of the memory may be identified by addresses.

Here, the address decoding unit may compare the address of the memory received from the processor core with a previously set memory address value to access the cache memory operating in conjunction with the area of the memory to be accessed by the processor core.

Here, the video decoding apparatus may further include an instruction cache unit configured to cache the program for decoding the video in the cache memory operating in conjunction with the program memory.

Here, the processor core may generate the frames by decoding the video based on the program of the instruction cache unit for decoding the video and the data of the data cache unit required to decode the video.

Here, the frame cache unit may temporarily store the frames generated by the processor core.

Here, the frame cache unit may perform a cache clear for storing the frames temporarily stored in the frame cache unit to the frame memory so that frame consistency is maintained between the frame cache unit and the frame memory.

In other example embodiments, a video decoding method using a frame cache is performed by a video decoding apparatus using the frame cache and includes: determining an area of a memory to be accessed by a processor core based on an address of the memory received from the processor core; generating frames by decoding a video based on a video decoding program and data received from the determined area of the memory; and temporarily storing the generated frames in a frame cache unit operating in conjunction with a frame memory.

Here, the video decoding method may further include performing a cache clear for storing the frames temporarily stored in the frame cache unit to the frame memory so that frame consistency is maintained between the frame cache unit and the frame memory.

### BRIEF DESCRIPTION OF DRAWINGS

Example embodiments of the present invention will become more apparent by describing in detail example embodiments of the present invention with reference to the accompanying drawings, in which:

FIG. 1A is an example diagram of an existing video decoding system;

FIG. 1B is an example diagram of an existing video decoding system;

FIG. 2 is a block diagram of a video decoding apparatus using a frame cache according to an example embodiment of the present invention;

FIG. 3 is an example diagram illustrating areas of a memory used for video decoding according to an example embodiment of the present invention;

FIG. 4 is an example diagram illustrating a configuration of a frame cache unit according to an example embodiment of the present invention; and

FIG. 5 is a flowchart illustrating a video decoding method using a frame cache according to an example embodiment of the present invention.

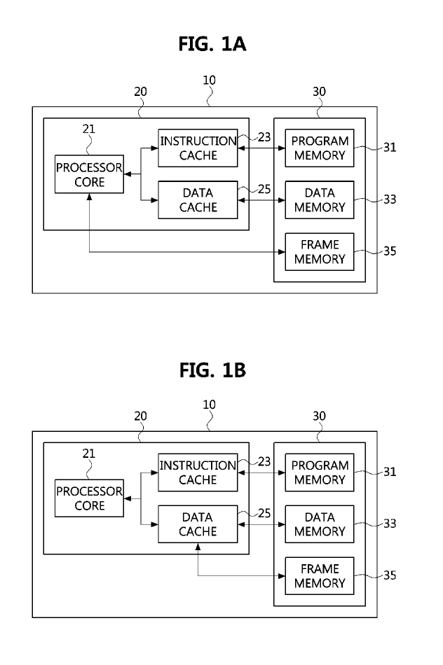

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

It will be understood that, although the terms “first,” “second,” “A,” “B,” etc. may be used herein in reference to elements of the invention, such elements should not be construed to as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.). It will be understood that the term “connect” does not only denotes a physical connection of an element stated herein but also denotes an electrical connection, a network connection, and so on.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, parts and/or combinations thereof, but do not preclude the presence or addition of one or more other features, numbers, steps, operations, elements, parts, and/or combinations thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

A video decoding apparatus which will be described below can receive a compressed video from a server for providing a multimedia service, and restore the compressed video to an original video.

In general, a video may consist of a plurality of frames. Here, a frame may indicate a still picture having a predetermined area, such as an image or a block, but is not limited thereto.

The image quality of a video may be generally determined by the number of frames played for one second by a display device or a frame rate. For example, an existing television (TV) plays 20 to 30 frames per second to provide a video, whereas a high definition television (HDTV) plays 60 frames per second and an ultra HDTV plays 120 frames per second to provide clearer and smoother images than the existing TV.

In this way, a high-definition video includes a large number of frames per second, and thus the overall capacity thereof may increase. However, with the current Internet transmission speed, it is neither possible to transmit an original high-definition video to a plurality of users as it is at high speed nor to efficiently record the high-definition video in various storage media.

Therefore, the video is encoded using various video standards, such as H.264/advanced video coding (AVC), VC-1, audio video coding standard (AVS), high efficiency video coding (HEVC), and scalable video coding (SVC).

The encoded video may be rapidly transmitted to a video decoding apparatus in real time or not in real time through various communication interfaces, such as cable, Universal Serial Bus (USB), Bluetooth, wireless-fidelity (WiFi), third generation (3G), and long term evolution (LTE) communication interfaces, or may be efficiently stored in a storage medium, such as a digital versatile disk (DVD).

Here, the video decoding apparatus may be implemented by a user terminal, such as a computer, a laptop computer, a smart phone, a tablet personal computer (PC), a personal digital assistant (PDA), or a portable multimedia player (PMP), or a home appliance, such as a smart TV, to decode an encoded video. However, the video decoding apparatus is not limited to the above, and may be implemented by various types of equipment which include a communication device capable of receiving an encoded video via wired and wireless networks and a storage device storing a program and data required to decode the video and have an information processing function for decoding the video using the communication device and the storage device.

Hereinafter, example embodiments of the present invention will be described in detail with reference to the accompanying drawings.

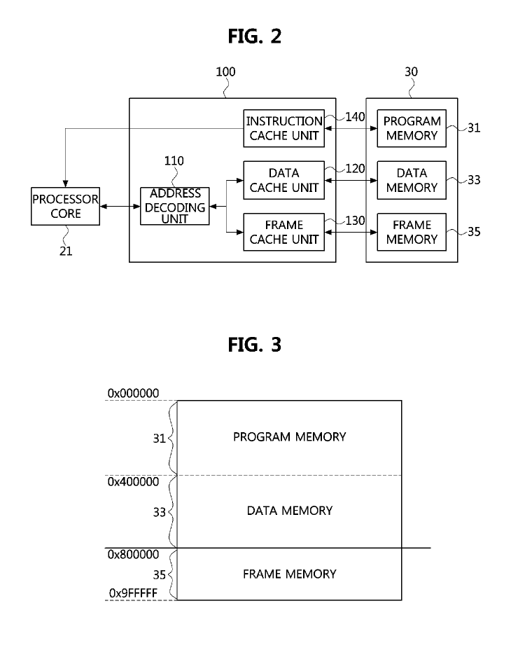

FIG. 2 is a block diagram of a video decoding apparatus using a frame cache according to an example embodiment of the present invention, and FIG. 3 is an example diagram illustrating areas of a memory used for video decoding according to an example embodiment of the present invention.

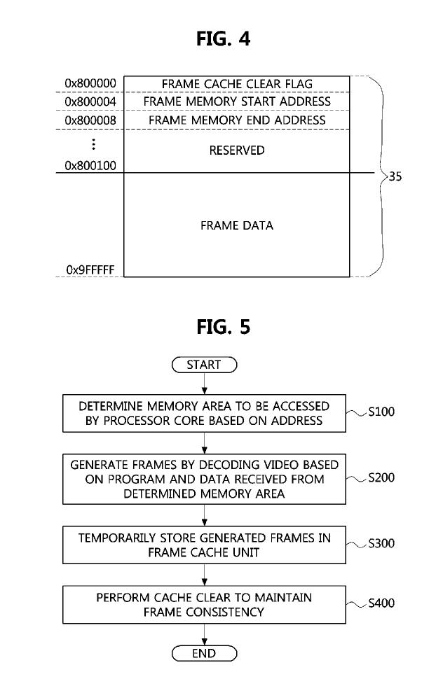

Also, FIG. 4 is an example diagram illustrating a configuration of a frame cache unit according to an example embodiment of the present invention.

Referring to FIG. 2, a video decoding apparatus 100 may include an address decoding unit 110, a data cache unit 120, and a frame cache unit 130, and may further include an instruction cache unit 140.

The video decoding apparatus 100 may be implemented by a video decoding system which includes a communication device receiving an encoded video and a storage device storing data required to decode the encoded video and has an information processing function so as to decode the video using the stored data.

Here, the video decoding system may include a processor including a processor core 21 which decodes a video and a cache memory which temporarily stores data accessed very frequently by the processor core 21 in the processor, and a memory 30 which stores a program or data required to decode the video or stores frames decoded by the processor core 21, but is not limited to this configuration.

According to related art, a cache memory is divided into an instruction cache and a data cache. Here, a video decoding program accessed by the processor core 21 is temporarily stored in the instruction cache, and data which is accessed by the processor core 21 and required to perform video decoding is temporarily stored in the data cache. At this time, if the processor core 21 directly accesses the memory 30 to read or write a frame, a delay may occur. Therefore, the processor core 21 is configured to access a frame through the data cache so that video decoding performance may be improved.

However, both data and frames are cached in the data cache, and thus when a cache clear for maintaining frame consistency between the data cache and the memory 30 is performed, data used to perform video decoding as well as frames may be written back into the memory 30. As a result, the related art has a problem in that the performance of the video decoding system may be degraded due to a delay occurring in the process of clearing the data cache.

To solve this problem of the related art, in an example embodiment of the present invention, the data cache is divided into the data cache unit 120 for caching data required to perform video decoding and the frame cache unit 130 for caching frames generated by decoding a video, so that a delay which may occur in a process of clearing the data cache can be minimized.

Therefore, the video decoding apparatus 100 proposed by an example embodiment of the present invention may include the address decoding unit 110, the data cache unit 120, and the frame cache unit 130, and may further include the instruction cache unit 140.

The address decoding unit 110 may determine an area of the memory 30 to be accessed by the processor core 21 using an address of the memory 30 received from the processor core 21.

Here, areas of the memory 30 may be classified as the areas of a program memory 31, a data memory 33, and a frame memory 35, and each memory area may be identified by a previously set address.

For example, assuming that an address space from 0x000000 to 0x9FFFFF is a memory area as shown in FIG. 3, an address space from 0x000000 to 0x3FFFFF may be set in advance as the program memory 31 storing a program for performing video decoding or an execution file of the program.

Also, an address space from 0x400000 to 0x7FFFFF may be set as the data memory 33 storing data required to perform video decoding, and an address space from 0x800000 to 0x9FFFFF may be set in advance as the frame memory 35 storing a video decoded by the processor core 21 in the form of frames.

In this example, the memory areas of the sequential address spaces are classified and set in advance as the program memory 31, the data memory 33, and the frame memory 35, but are not limited thereto. The respective memory areas may be set as non-sequential address spaces or different storage devices, such as a random access memory (RAM), a read only memory (ROM), and a flash memory.

In this way, the memory areas classified as the program memory 31, the data memory 33, and the frame memory 35 may operate in conjunction with a cache memory which temporarily stores data accessed by the processor core 21. Also, the instruction cache unit 140 which operates in conjunction with the program memory 31 to cache the program for performing video decoding or the execution file of the program may be included.

In particular, in an example embodiment of the present invention, the data cache may be divided into the data cache unit 120 and the frame cache unit 130 and managed. The data cache unit 120 may operate in conjunction with the data memory 33 to cache data required to perform video decoding, such as index information, flag start information, or flag end information, so that the processor core 21 can access the area of the data memory 33.

Also, the frame cache unit 130 operates in conjunction with the frame memory 35 to cache frames of a decoded video so that the processor core 21 can access the area of the frame memory 35.

Therefore, the address decoding unit 110 may compare an address of the memory 30 received from the processor core 21 with a previously set memory address value to access the cache memory operating in conjunction with an area of the memory 30 to be accessed by the processor core 21.

Using the previously set memory areas of FIG. 3 as an example, when the address of the memory 30 received from the processor core 21 is included in 0x000000 to 0x3FFFFF, it is determined that the area of the memory 30 to be accessed by the processor core 21 is the program memory 31, and it is possible to read or write a program for performing video decoding or an execution file of the program through the instruction cache unit 140 operating in conjunction with the program memory 31.

When the address of the memory 30 received from the processor core 21 is included in 0x400000 to 0x7FFFFF, it is determined that the area of the memory 30 to be accessed by the processor core 21 is the data memory 33, and it is possible to read or write data required to perform video decoding through the data cache unit 120 operating in conjunction with the data memory 33.

Also, when the address of the memory 30 received from the processor core 21 is included in 0x800000 to 0x9FFFFF, it is determined that the area of the memory 30 to be accessed by the processor core 21 is the frame memory 35, and it is possible to read or write the frames obtained by decoding the video through the frame cache unit 130 operating in conjunction with the frame memory 35.

In this way, the processor core 21 can access a video decoding program, data required to perform video decoding, and frames using addresses of memory areas, thereby decoding a video to generate frames.

The generated frames may be temporarily stored in the frame cache unit 130. At this time, the frame cache unit 130 may perform a cache clear for storing the temporarily stored frames to the frame memory 35, thereby maintaining frame consistency between the frame cache unit 130 and the frame memory 35.

To perform the cache clear, the frame cache unit 130 may include a frame cache clear flag setting space, a frame memory start address storage space, a frame memory end address storage space, or a frame storage space as shown in FIG. 4.

When 1 is set in the frame cache clear flag setting space, the cache clear is performed, and the frames temporarily stored in the frame cache unit 130 may be stored in a memory space from a frame memory start address to a frame memory end address.

In this way, a delay occurring in an existing video decoding system due to a cache clear process of storing both data and frames temporarily stored in a data cache in a memory so as to store the frames in the memory is minimized using a frame cache, so that the overall performance of the video decoding system can be improved.

FIG. 5 is a flowchart illustrating a video decoding method using a frame cache according to an example embodiment of the present invention.

Referring to FIG. 5, the video decoding method may include an operation of determining an area of a memory to be accessed by a processor core (S100), an operation of generating frames by decoding a video based on a video decoding program and data received from the determined area of the memory (S200), and an operation of temporarily storing the generated frames in a frame cache unit operating in conjunction with a frame memory (S300).

In addition, the video decoding method may further include an operation of storing the frames temporarily stored in the frame cache unit to the frame memory so that frame consistency is maintained (S400).

Here, the video decoding method may be performed by the video decoding apparatus 100, which may indicate a user terminal that includes a communication device receiving an encoded video and a storage device storing data required to decode the encoded video and has an information processing function so as to perform video decoding, but is not limited thereto.

To perform video decoding, first, the area of the memory 30 to be accessed by the processor core 21 may be determined based on an address of the memory 30 received from the processor core 21 (S100).

Areas of the memory 30 may be classified as the areas of the program memory 31, the data memory 33, and the frame memory 35, and each memory area may be identified by a previously set address.

The areas of the memory 30 classified in this way may operate in conjunction with a cache memory. In other words, the program memory 31 may operate in conjunction with the instruction cache unit 140 which caches a program for performing video decoding.

In particular, in an example embodiment of the present invention, a data cache is divided into the data cache unit 120 and the frame cache unit 130 and managed. Therefore, the data memory 33 may operate in conjunction with the data cache unit 120 which caches data required to perform video decoding, and the frame memory 35 may operate in conjunction with the frame cache unit 130 which caches frames.

Therefore, when the area of the memory 30 to be accessed by the processor core 21 is determined by comparing the address of the memory 30 received from the processor core 21 with a previously set memory address value, the processor core 21 may access the cache memory operating in conjunction with the area of the memory 30 to read or write required data.

Based on the video decoding program and the data received from the memory area in this way, video decoding may be performed to generate the frames (S200).

More specifically, the processor core 21 may access the instruction cache unit 140 and the data cache unit 120 to receive the video decoding program and the data required to perform video decoding, thereby generating the frames.

The generated frames may be temporarily stored in the frame cache unit 130 operating in conjunction with the frame memory 35 (S300).

Here, a cache clear for storing the frames temporarily stored in the frame cache unit 130 to the frame memory 35 may be performed so that frame consistency can be maintained between the frame cache unit 130 and the frame memory 35 (S400).

In this way, a delay occurring in an existing video decoding system due to a cache clear process of storing both data and frames temporarily stored in a data cache in a memory so as to store the frames in the memory is minimized using a frame cache, so that the overall performance of the video decoding system can be improved.

According to the above-described apparatus using a frame cache according to an example embodiment of the present invention and a method of using the apparatus, a delay occurring in a cache clear process is minimized using the frame cache in a processor-based video decoding system, so that the performance of the video decoding system can be improved.

Also, the method can be universally applied to various video standards, such as H.264/AVC, VC-1, AVS, HEVC, and SVC, to perform video decoding.

While the example embodiments of the present invention and their advantages have been described in detail, it should be understood that various changes, substitutions and alterations may be made herein without departing from the scope of the invention.

What is claimed is:

1. A video decoding apparatus using a frame cache and implemented by a video decoding system, the video decoding apparatus comprising:
an address decoding unit configured to determine an area of a memory to be accessed by a processor core based on an address of the memory received from the processor core;
a data cache unit configured to cache data required to decode a video in a cache memory operating in conjunction with a data memory so that the processor core accesses an area of the data memory due to the address decoding unit; and
a frame cache unit configured to cache frames of the video in the cache memory operating in conjunction with a frame memory so that the processor core accesses an area of the frame memory due to the address decoding unit.

2. The video decoding apparatus of claim 1, wherein areas of the memory are classified as:
a program memory configured to store a program for decoding the video;
the data memory configured to store the data required to decode the video; and
the frame memory configured to store the video decoded by the processor core in a form of frames, and
the respective classified areas of the memory are identified by addresses.

3. The video decoding apparatus of claim 2, wherein the address decoding unit compares the address of the memory received from the processor core with a previously set memory address value to access the cache memory operating in conjunction with the area of the memory to be accessed by the processor core.

4. The video decoding apparatus of claim 2, further comprising an instruction cache unit configured to cache the program for decoding the video in the cache memory operating in conjunction with the program memory.

5. The video decoding apparatus of claim 4, wherein the processor core generates the frames by decoding the video based on the program of the instruction cache unit for decoding the video and the data of the data cache unit required to decode the video.

6. The video decoding apparatus of claim 5, wherein the frame cache unit temporarily stores the frames generated by the processor core.

7. The video decoding apparatus of claim 6, wherein the frame cache unit performs a cache clear for storing the frames temporarily stored in the frame cache unit to the frame memory so that frame consistency is maintained between the frame cache unit and the frame memory.

8. A video decoding method performed by a video decoding apparatus using a frame cache, the video decoding method comprising:
determining an area of a memory to be accessed by a processor core based on an address of the memory received from the processor core;
generating frames by decoding a video based on a video decoding program and data received from the determined area of the memory; and
temporarily storing the generated frames in a frame cache unit in a cache memory operating in conjunction with a frame memory.

9. The video decoding method of claim 8, further comprising performing a cache clear for storing the frames temporarily stored in the frame cache unit to the frame memory so that frame consistency is maintained between the frame cache unit and the frame memory.

10. The video decoding method of claim 8, wherein areas of the memory are classified as:
a program memory configured to store the video decoding program;
a data memory configured to store the data required to decode the video; and
the frame memory configured to store the video decoded by the processor core in a form of frames, and
the respective classified areas of the memory are identified by addresses.

11. The video decoding method of claim 10, wherein, in order to enable access of the processor core, the program memory operates in conjunction with an instruction cache unit in the cache memory caching the video decoding program;
the data memory operates in conjunction with a data cache unit in the cache memory caching the data required to decode the video; and
the frame memory operates in conjunction with the frame cache unit in the cache memory caching the frames.

12. The video decoding method of claim 11, wherein the determining of the area of the memory comprises comparing the address of the memory received from the processor core with a previously set memory address value to access the cache memory operating in conjunction with the area of the memory to be accessed by the processor core.
